(19) United States
(12) Patent Application Publication
(10) Pub. No.: US 2010/0176726 A1
(43) Pub. Date: Jul. 15, 2010

(54) HIGH-PRESSURE DISCHARGE LAMP WITH IMPROVED IGNITION QUALITY AND IGNITION DEVICE FOR A GAS DISCHARGE LAMP

(75) Inventors: Andreas Kloss, Neubiberg (DE); Steffen Walter, Oberpframmern (DE); Bernhard Schalk, Eching (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/602,778

(22) PCT Filed: Jun. 6, 2007
(86) PCT No.: PCT/EP2007/055558

§ 371 Date: Dec. 3, 2009

(51) Int. Cl. H01J 61/54

(52) U.S. Cl. 315/51; 315/56

(57) ABSTRACT

A high-pressure discharge lamp may include a discharge vessel; an ignition device which is configured to generate high-voltage pulses in the lamp and contains at least one spiral pulse generator being integrated in the lamp, wherein the charging voltage of the ignition device has the opposite polarity to the open-circuit voltage of an operating apparatus, this charging voltage is likewise provided by the operating apparatus, and the sum of the two voltages is applied to the ignition device.

### TECHNICAL FIELD

The invention relates to a high-pressure discharge lamp according to the precharacterizing clause of claim 1. Such lamps are in particular high-pressure discharge lamps for general lighting or for photo-optical purposes. The invention furthermore relates to an ignition device with an improved operating process, which may be used in particular for such a lamp.

### PRIOR ART

The problem of igniting high-pressure discharge lamps is currently resolved by integrating the ignition apparatus into the ballast apparatus. A disadvantage of this is that the supply leads must be made high-voltage proof.

In the past, there have repeatedly been attempts to integrate the ignition unit into the lamp. Primarily, attempts have been made to integrate it into the cap. Particularly effective ignition, offering high pulses, is achieved by means of so-called spiral pulse generators such as are disclosed for example in U.S. Pat. No. 3,289,015. Some time ago, such apparatuses were proposed for various high-pressure discharge lamps such as metal halide lamps or high-pressure sodium lamps, see for example U.S. Pat. No. 4,325,004 and U.S. Pat. No. 4,353,012. They were not however widely successful, because on the one hand they are too expensive. On the other hand, the advantage of building them into the cap is not sufficient, since the problem of feeding the high voltage into the bulb remains. The likelihood of damage to the lamp, whether insulation problems or breakdown in the cap, therefore increases greatly. Previously, it has not generally been possible to heat conventional ignition apparatus to more than 100° C.-150° C. The voltage generated then had to be fed to the lamp, which requires supply leads and lamp fixtures with corresponding high-voltage strength, typically about 5 kV or more.

The functionality of a spiral pulse generator will be explained briefly below with the aid of FIGS. 1-3. A spiral pulse generator consists of a winding of two conductive layers, between which an insulation material is placed. The material of the insulation material may be a material with a high dielectric constant or a material with a high permeability, or a mixture of the two materials. FIG. 2a shows the representation of a schematic structure of a spiral pulse generator. The conductive layer A is contacted at the end points A1 and A2. The layer B extending parallel is contacted only at one end point B1. The terminal A1 is at the voltage U₀, as provided by the electronic operating apparatus. The terminal A2 is the output, and is connected to the gas discharge lamp. The terminal B1 of the conductive layer B is connected via a charging resistor 7 to the ground terminal. The two conductive layers, with the dielectric lying between them, form a capacitor which is charged to the open-circuit voltage U₀ via the terminals A1 and B1. The terminals A1 and B1 are connected to a high-speed switch 3, for example a spark gap.

The switch switches at a particular threshold voltage, which is somewhat lower than U₀. After the switch is closed, a voltage pulse is formed at the spiral pulse generator and propagates like a wave from the point of the switch along the spiral pulse generator to the point A2, where it is reflected and propagates back again. A voltage UA, which can be expressed as UA=2×n×U₀×η, is then built up at the point A2. η is the efficiency of the spiral pulse generator. After ignition of the lamp, the lamp current is fed through the conductive layer A in order to operate the lamp.

The spiral pulse generator now used is in particular a so-called LTCC component. This material is a special ceramic, which can be made thermally stable up to 500° C. or 600° C. LTCC has in fact already been used in connection with lamps, see US 2003/0001519 and U.S. Pat. No. 6,853,151. Nevertheless, it was used for very different purposes in lamps which experience scarcely any thermal stress, with typical temperatures lower than 100° C. The particular benefit of the high thermal stability of LTCC in connection with the ignition of high-pressure discharge lamps, such as above all metal halide lamps with ignition problems, has not yet been recognized.

A double generator has previously been used in order to generate particularly high voltages, see U.S. Pat. No. 4,608,521. This method, however, has the disadvantage that it can only be used for lamps with caps on both sides since a very high voltage is applied to the two electrodes.

### OBJECT

It is an object of the present invention to provide a high-pressure discharge lamp, which may also be capped on one side, the ignition behavior of which is significantly improved in comparison with previous lamps and which is not at risk of damage due to introduction of the high voltage into the outer bulb of the lamp. This applies in particular for metal halide lamps, in which case the material of the discharge vessel may be either quartz glass or ceramic.

This object is achieved by the characterizing features of claims 1 and 5.

Particularly advantageous configurations may be found in the dependent claims.

It is also an object of the present invention to provide an ignition device, which can be driven by a refined method and therefore generate high voltages of more than 15 kV, and at the same time can be constructed more compactly. This object is achieved by the characterizing features of claim 8.

According to the invention a high-voltage pulse of at least 15 kV, which is required for example in order to ignite a lamp, is generated by means of a structure having special heat-resistant spiral pulse generators which are integrated in the immediate vicinity of the discharge vessel in the outer bulb. This allows not only cold ignition but also hot reignition.

### SUMMARY OF THE INVENTION

To date, in order to ignite gas discharge lamps, an ignition voltage is generated by spiral pulse generators from a charging voltage U₀. The ignition voltage U_{A} is given as a function of the charging voltage U₀ by U_{A}=2×n×U₀×η, the efficiency ηbeing given by η=1−1.16*(AD−ID)/AD. AD is the outer diameter of the spiral pulse generator, and ID is its inner diameter. When connected according to the prior art, the maximum value of the charging voltage is given by the maximum value of the open-circuit voltage of the operating apparatus. This is usually about 400 V. Since the charging voltage enters directly into the output value, i.e. the ignition voltage, the maximum value of the ignition voltage can be increased significantly by raising the charging value.

It is therefore proposed to provide a further voltage, by means of which a higher charging voltage can be applied to the spiral pulse generator. This may be done by means of an increased charging voltage. It is however also possible to use a negative voltage which, together with the positive open-circuit voltage, gives the charging voltage.

### BRIEF DESCRIPTION OF THE DRAWING(S)

FIG. 1 Basic structure of a gas discharge lamp containing an ignition arrangement with a spiral pulse generator in the outer bulb according to the prior art.

FIG. 2a Basic structure of a spiral pulse generator.

FIG. 2b Simplified representation of a spiral pulse generator.

FIG. 3 Circuit of a lamp system with a spiral pulse generator according to the prior art.

FIG. 4 Basic structure of a first embodiment of the lamp system according to the invention, containing an ignition arrangement with a spiral pulse generator which has its own charging voltage.

FIG. 5 Circuit diagram of an i-stage Villard cascade.

FIG. 6 Basic structure of a second embodiment of the lamp system according to the invention, containing an ignition arrangement with a spiral pulse generator which is charged via a Villard cascade.

FIG. 7 Basic structure of a second embodiment of the lamp system according to the invention, containing an ignition arrangement with a spiral pulse generator which is charged via an upstream spiral pulse generator.

FIG. 8 Examples of the output voltage U_{A} of a spiral pulse generator without a pre-voltage (signal 81) and with −U₀ as the pre-voltage (signal 83).

FIG. 9 Frequency dependency of the gain of a 6-stage diode cascade with capacitors which have a capacitance of 22 nF, with a load of 1 MΩ.

FIG. 10 Exemplary structure of a 3-stage diode cascade in LTCC design.

FIG. 11 Structure of eight double spiral pulse generator according to the third embodiment.

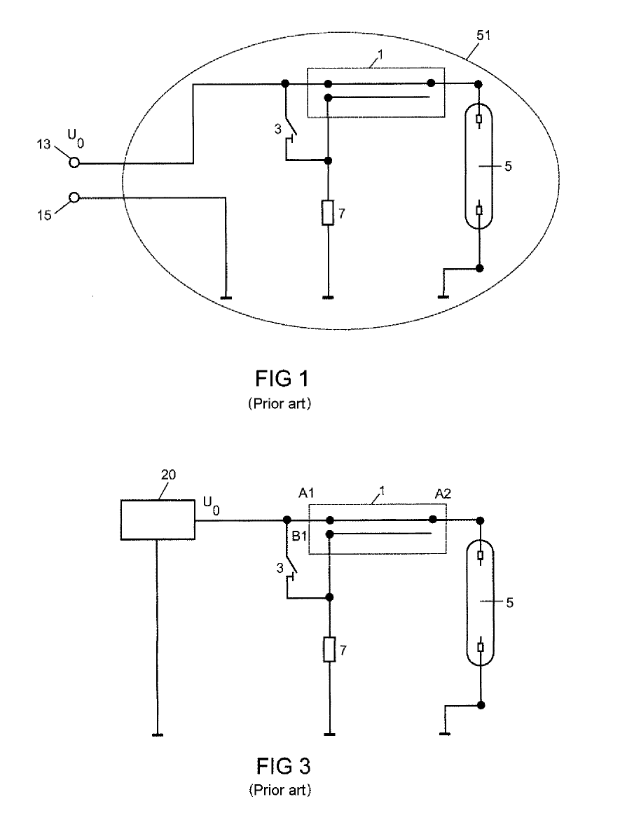

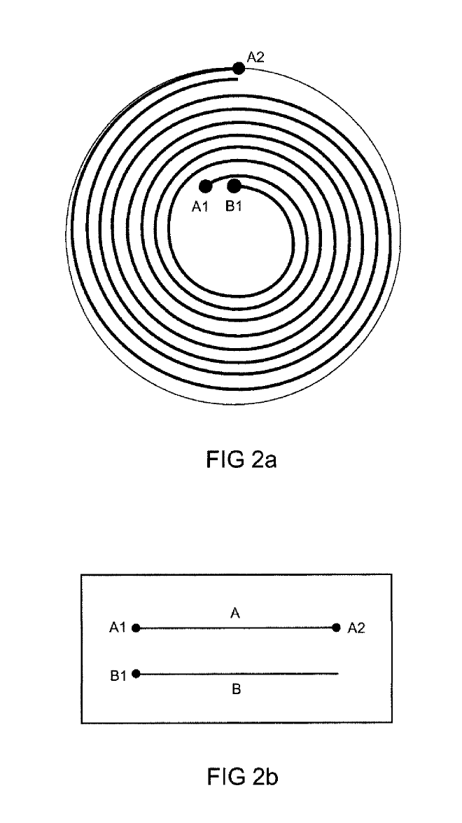

### PREFERRED EMBODIMENT OF THE INVENTION

According to the invention the spiral pulse generator, which supplies the gas discharge lamp with an ignition voltage, is charged not with the open-circuit voltage (13-15) of the operating apparatus but with a higher voltage, which may be generated in various ways. In other regards the functionality corresponds to the functionality of the spiral pulse generator according to the prior art, although much higher ignition voltages can be provided for the discharge lamp owing to the increased charging voltage.

### First Embodiment

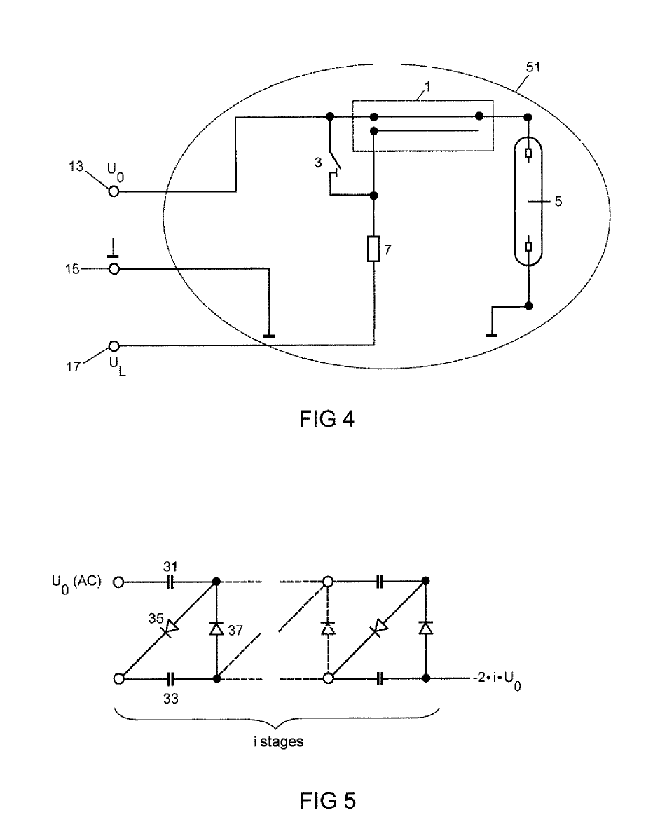

In the first embodiment, as may be seen in FIG. 4, a second charging voltage 17 in addition to the known open-circuit voltage is generated by the operating apparatus and fed to the ignition apparatus with the spiral pulse generator according to the invention. The charging voltage U_{L} (17) preferably has an opposite sign to the open-circuit voltage U₀ (13). The voltage applied to the spiral pulse generator therefore reaches U₀-U_{L}, and in the method according to the invention is therefore higher by the magnitude of U_{L} than the charging voltage according to the prior art. FIG. 4 shows a gas discharge lamp according to the invention, in which the discharge tube 5 and the spiral pulse generator 1 with its circuitry are fitted in the outer bulb 51 of the gas discharge lamp. Although three voltage potentials must be fed into the lamp in this embodiment, all three potentials vary at a comparatively low voltage level so that the feed-throughs into the lamp bulb are loaded less.

### Second Embodiment

If the gas discharge lamp is furthermore to be produced with two electrical leads, then the increased charging voltage may be generated from the open-circuit voltage of the operating apparatus. Depending on whether the open-circuit voltage of the operating apparatus is a DC voltage or an AC voltage, various methods may be envisaged.

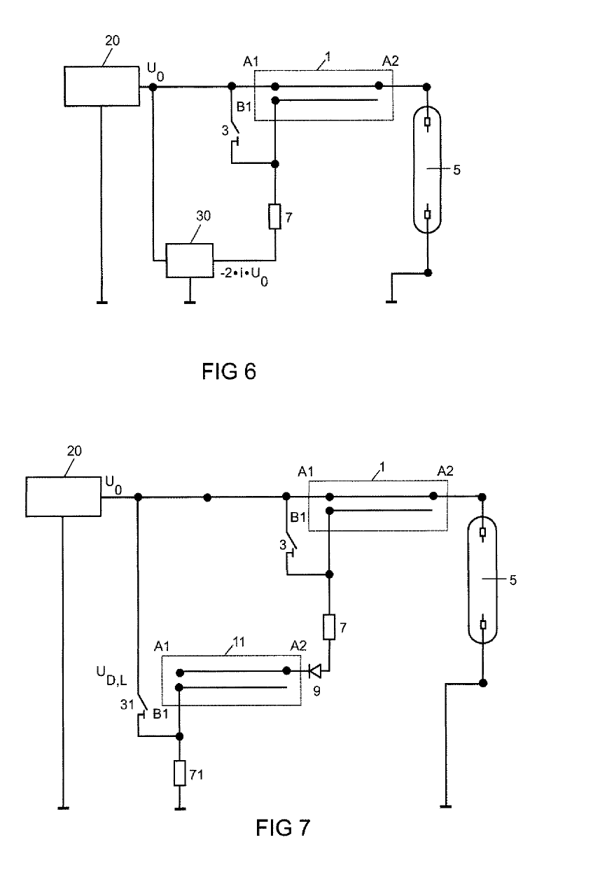

The second embodiment relates to an embodiment in which an AC voltage is provided as the open-circuit voltage by the operating apparatus. FIG. 5 shows the circuit diagram of a voltage multiplier circuit. This circuit is also known as a Villard cascade or a Cockcroft-Walton generator. A stage of the cascade circuit respectively consists of two capacitors 31 and 33 and two diodes 35 and 37, which are respectively connected in the known manner. At each stage, this cascade circuit doubles the voltage. The output voltage is therefore given as: U_{V}=2*i*U₀. After ignition of the lamp, the lamp voltage, which is generally much less than the open-circuit voltage of the operating apparatus, is applied to the cascade circuit. The output voltage U_{V} therefore remains below the threshold voltage of the switching element 3, so that the ignition circuit is disabled after full ignition of the lamp. FIG. 6 shows a block diagram of the second embodiment, in which the input voltage U₀ is also used as the input voltage of the Villard cascade 30. The output of the cascade is connected via a charging resistor 7 to the spiral pulse generator. With appropriate dimensioning of the cascade, however, the charging resistor is dispensable. The only prerequisite for the function of the circuit is an AC voltage as the input voltage U₀.

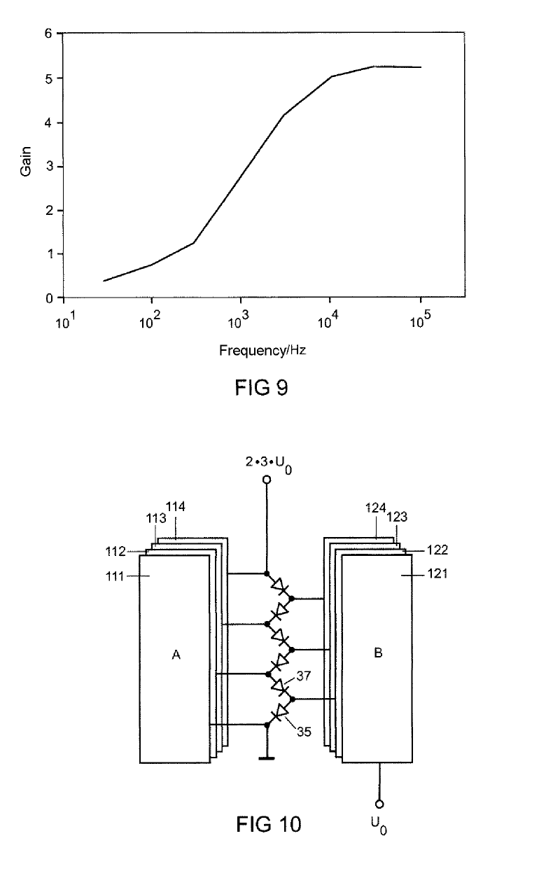

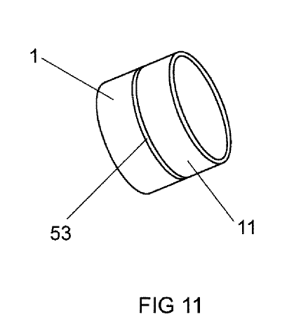

Since the ignition device is preferably installed in the outer bulb of the gas discharge lamp, it is also necessary to make the latter correspondingly thermally stable. This is achieved by thermally stable materials and connections. SiC diodes, which allow a barrier layer temperature of up to 600° C., are used as diodes for the cascade. The capacitors, like the spiral pulse generator, are configured in an LTCC design which makes them thermally stable up to 800° C. Since correspondingly high capacitances are required for rapid and reliable ignition, a dielectric with a high dielectric constant is used. In this case, for example, BaTiO₃ may be used. The BaTiO₃ is provided with appropriate sintering additives and then processed by a known LTCC method. Preferably, a double stack is constructed as represented in FIG. 10. The dielectric material is located between the conductive layers 111, 112, 113 and 114 of the stack A and the conductive layers 121, 122, 123 and 124 of the stack B. One capacitor is therefore respectively created between the layers, i.e. three capacitors per stack. The SiC diodes, which are preferably applied as dice directly onto the substrate and connected through vias to the corresponding conductive layers, may be arranged between the stacks. FIG. 10 shows the schematic circuitry of the stack with the SiC diodes. Connection by vias is prior art for LTCC components, and will not therefore be explained in detail. The SiC diodes may be connected to the LTCC capacitors by all connection methods which are known in LTCC methods and are suitable for this temperature. Preferably, the SiC diodes are connected to the LTCC capacitors by bonding. For interconnection, contact lugs are fed out from the conductive layers. The vias which have corresponding contact surfaces on the component side, onto which the bonding connections of the SiC diodes are applied, may be incorporated into the contact lugs. The SiC diodes may naturally also be contacted using suitable high-temperature solder or by means of welded connections.

Naturally, the Villard cascade is not restricted to three stages. Depending on the high-pressure discharge lamp and the configuration of the spiral pulse generator, the Villard cascade may consist of 1-10 stages.

### Third Embodiment

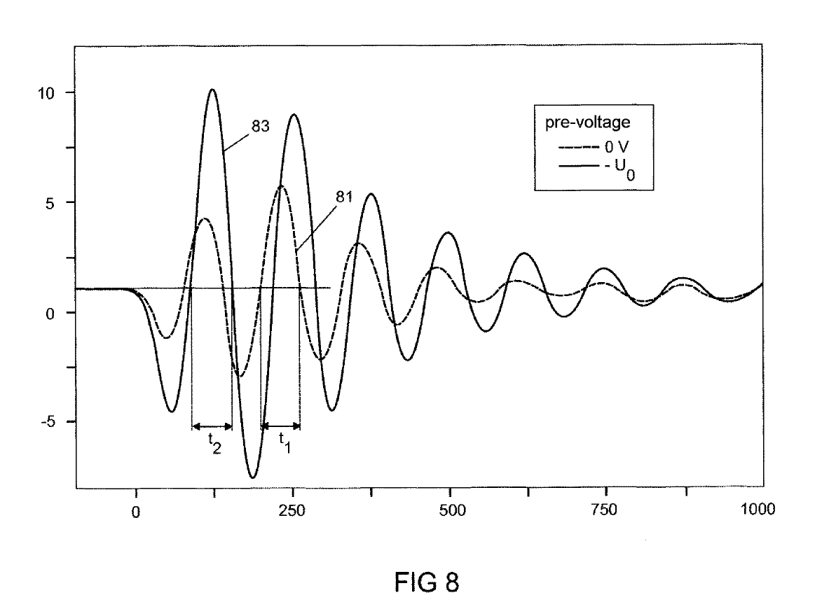

In the third embodiment, the type of open-circuit voltage is not important for the function of the ignition mechanism. At the same time, very high ignition voltages can be produced which make hot reignition of the lamp readily possible. In the third embodiment, as represented in FIG. 7, two spiral pulse generators are connected in succession. The first spiral pulse generator 11 is supplied in a manner known per se by the open-circuit voltage U₀ of the operating apparatus. The switching element 31, preferably a spark gap, is dimensioned so that the threshold voltage lies just below the open-circuit voltage U₀. The first spiral pulse generator therefore generates an output voltage of: U_{SPG1}=2×n₁×U₀×n₁. The output voltage pulses are sent through an arbitrarily biased diode path 9 and a charging resistor 7 to the input of the second spiral pulse generator 1. The second spiral pulse generator 1 is therefore charged slowly by a multiplicity of pulses of the first spiral pulse generator to the peak value of the output voltage U_{SPG1} of the first spiral pulse generator 11. In order for this to work, the diode 9 must be capable of switching through the short pulses of the first spiral pulse generator and blocking the negative part of the pulse quickly enough, which places corresponding demands on the switching speed of the diode 9. The output pulse shape of a spiral pulse generator is represented for example in FIG. 8. Signal 83 is the output voltage of a spiral pulse generator with a pre-voltage U₀, and signal 81 is the output voltage without a pre-voltage, i.e. the pre-voltage is 0 V.

The time axis is plotted in ns, and the unit of the vertical axis is kV. It may be seen clearly that ignition voltages of about 10 kV are possible with a base pulse width t₂ of the second spiral pulse generator equal to about 100 ns. Owing to the base pulse width t₁ of the first spiral pulse generator, it is necessary to have a diode whose blocking delay time is less than half the base pulse width t₁. The second spiral pulse generator is therefore charged by the sequence of counter-poled pulses from the first spiral pulse generator, and only partially discharged again. In order to keep the discharging small, it is preferable to use a diode whose blocking delay time is less than one fourth of the base pulse width t₁. The second threshold value switch 3 is configured so that it switches on with a voltage slightly below the peak value U_{SPG1} of the output voltage of the first spiral pulse generator. The output voltage is measured behind the charging resistor 7 and the high-speed diode 9, so that the voltages across these parts are also included. The second threshold value switch is also preferably a spark gap. The output voltage, i.e. the ignition voltage, it is therefore given as: U_{SPG2}=U_{Z}=2×n₁×U₀×η₁×2×n₂×η₂, where n₁ is the number of turns of the first spiral pulse generator, n₂ is the number of turns of the second spiral pulse generator, η₁ is the efficiency of the first spiral pulse generator and η₂ is the efficiency of the second spiral pulse generator.

FIG. 11 represents a preferred embodiment, in which the two spiral pulse generators are integrated in one component. This is achieved by the spiral pulse generators 1 and 11 being wound together and by a suitable insulation 53 being co-wound and sintered between the sheets. In this way, so to speak, two spiral pulse generators which offer favorable conditions for compact interconnection are created next to one another.

1. A high-pressure discharge lamp, comprising:
a discharge vessel;
an ignition device which is configured to generate high-voltage pulses in the lamp and comprises at least one spiral pulse generator being integrated in the lamp,
wherein the charging voltage of the ignition device has the opposite polarity to the open-circuit voltage of an operating apparatus, this charging voltage is likewise provided by the operating apparatus, and the sum of the two voltages is applied to the ignition device.

2. The high-pressure discharge lamp as claimed in claim 1, wherein the ignition device furthermore comprises a threshold value switch.

3. The high-pressure discharge lamp as claimed in claim 2, wherein the threshold value switch is a spark gap.

4. The high-pressure discharge lamp as claimed in claim 1,
wherein the ignition device furthermore comprises a charging resistor.

5. A high-pressure discharge lamp, comprising: having
a discharge vessel,
an ignition device which is configured to generate high-voltage pulses in the lamp and comprises at least one spiral pulse generator being integrated in the outer bulb,
wherein the open-circuit voltage of an operating apparatus is increased by a device in the lamp or in the lamp cap, in order to apply the increased voltage to the spiral pulse generator as its charging voltage.

6. The high-pressure discharge lamp as claimed in claim 5, wherein the ignition device furthermore comprises a threshold value switch.

7. The high-pressure discharge lamp as claimed in claim 6, wherein the threshold value switch is a spark gap.

8. An ignition device, comprising:
a first spiral pulse generator and a first threshold value switch, which is arranged in an outer bulb or in the cap of a discharge gas lamp,
wherein the voltage applied to the lamp before ignition is increased by a device in order then to apply the increased voltage to the first spiral pulse generator so as to generate an ignition voltage.

9. The ignition device as claimed in claim 8, further comprising:
a voltage multiplier cascade configured to increase the voltage.

10. The ignition device as claimed in claim 9, wherein the voltage multiplier cascade comprises of high-temperature stable components.

11. The ignition device as claimed in claim 10, wherein the voltage multiplier cascade comprises of SiC diodes and capacitors in LTCC design.

12. The ignition device as claimed in claim 11, wherein the capacitors are constructed from one or two LTCC stacks.

13. The ignition device as claimed in claim 12, wherein the SiC diodes are applied onto the LTCC stack or the LTCC stacks and connected to the capacitors by means of LTCC interconnections.

14. The ignition device as claimed in claim 8, further comprising:
a second spiral pulse generator with a second threshold value switch, wherein the second spiral pulse generator is configured to increase the voltage.

15. The ignition device as claimed in claim 14, wherein an arbitrarily biased diode is connected between the first spiral pulse generator and the second spiral pulse generator, the blocking time of the diode being less than half the pulse width of a pulse of the first spiral pulse generator.

16. The ignition device as claimed in claim 14, wherein an arbitrarily biased diode is connected between the first spiral pulse generator and the second spiral pulse generator, the blocking time of the diode being less than one fourth of the pulse width of a pulse of the first spiral pulse generator.

17. The high-pressure discharge lamp as claimed in claim 1,
wherein the discharge vessel is fitted in an outer bulb of the high-pressure discharge lamp.

18. The high-pressure discharge lamp as claimed in claim 5,
wherein the discharge vessel is fitted in an outer bulb of the high-pressure discharge lamp.
